(19) United States
(12) Patent Application Publication
(10) Pub. No.: US 2024/0424483 A1
(43) Pub. Date: Dec. 26, 2024

(54) DYSPROSIUM-PRASEODYMIUM OXIDE SUPPORT FOR HETEROGENEOUS CATALYSIS

(71) Applicant: University of South Carolina, Columbia, SC (US)

(72) Inventors: Samuel Drummond, Columbia, SC (US); Jochen Lauterbach, Columbia, SC (US); Jennifer Naglic, Chapin, SC (US)

(73) Assignee: University of South Carolina, Columbia, SC (US)

(21) Appl. No.: 18/733,255

(22) Filed: Jun. 4, 2024

Related U.S. Application Data
(60) Provisional application No. 63/508,424, filed on Jun. 15, 2023.

(51) Int. Cl. B01J 23/10; C01B 3/04

(52) U.S. Cl. CPC B01J 23/10; C01B 3/047; C01B 2203/0277; C01B 2203/1064

(57) ABSTRACT

A catalyst support containing praseodymium oxide and dysprosium oxide, supported catalysts using the support, and methods of using the supported catalysts to catalyze the formation and degradation of ammonia.

### CROSS-REFERENCE TO RELATED APPLICATIONS

Priority is hereby claimed to provisional application Ser. No. 63/508,424, filed Jun. 15, 2023, which is incorporated herein by reference.

### FEDERAL FUNDING STATEMENT

This invention was made with government support under Grant Number DE-EE0009409, awarded by the Department of Energy. The government has certain rights in the invention.

### BACKGROUND

Heterogeneous catalysts are conventionally disposed on a supporting material having a very high surface area. The support serves to disperse the catalytically active material uniformly over a very large and reactant-accessible surface area. The support also functions as a physically and thermally stable foundation that enables the catalytically active materials (which can be very expensive) to be recycled and regenerated with minimal losses. Support materials are typically inactive (or relatively inactive) as compared to the catalytically active material deposited on the surface of the support material. But in some instances, the support itself also has a notable effect (good or bad) on catalytic activity. Refractory oxides, notably oxides of silicon, magnesium, titanium, aluminum, and zirconium (i.e., silica, magnesia, titania, alumina, and zirconia, respectively) are well known and widely used catalyst supports. Activated carbon is also a widely used catalyst support.

Two main methods are used to prepare supported catalysts: impregnation and co-precipitation. In the impregnation method, a suspension of the solid support is treated with a solution of a pre-catalyst. This deposits the pre-catalyst onto/into the porous support. The solution is removed and the resulting material is then activated (chemically and/or thermally) under conditions that convert the pre-catalyst to an active state. In the co-precipitation method, the catalytically active material and the support (or precursors of both) are dissolved in a homogeneous solution and precipitated simultaneously (for example, by acid or base addition or evaporation of the solvent). The catalytically active material and the support precipitate together. The initially precipitated material is conventionally further processed, such as by calcining, to yield the final supported catalyst.

A host of supported catalysts are previously described. For example, Myers et al., U.S. Pat. No. 4,161,463, issued Jul. 17, 1979, describes a method for disproportionating olefins. The method utilizes a catalyst consisting essentially of praseodymium oxide and/or dysprosium oxide disposed on a silica support. The oxides are then activated by calcining the supported catalyst in an atmosphere containing hydrogen or nitrogen, with or without added molecular oxygen (i.e., O₂). Here, though the praseodymium oxide and/or dysprosium oxide are the catalytically active agents of the catalyst, the support is silica. A similar supported catalyst is described in Barbotin et al., U.S. Pat. No. 6,949,489.

A great many supported catalysts have been developed for catalyzing Fischer-Tropsch-type reactions (i.e., for converting mixtures of carbon monoxide and hydrogen [“syngas” ] into liquid hydrocarbons). See, for example, Hu et al., U.S. Pat. No. 7,452,844. This patent describes a transition metal-based catalyst having a high surface area, a smooth, homogeneous surface morphology, and an essentially uniform distribution of cobalt throughout the support. Dysprosium and praseodymium may be included as metals in the catalytically active portion of the supported catalyst. The supports recited by Hu et al. are all conventional: aluminum oxide, γ-alumina, alumina monohydrate, alumina trihydrate, alumina-silica, magnesium silicate, silica, silicate, silicalite, y-zeolite, mordenite, titania, thoria, zirconia, niobia, hydrotalcite, kieselguhr, attapulgite clay, zinc oxide, and the like.

Similarly, several supported catalysts are described for use in ammoxidation reactions. See, for example, Brazdil et al., U.S. Pat. No. 10,626,082, which describes a catalytic composition for converting propylene and isobutylene to acrylonitrile.

Inoue et al., U.S. Pat. No. 8,445,903, describes a thin film transistor for mixed metal oxides that comprises a crystalline, hydrogen-containing indium oxide semiconductor film that may further comprise praseodymium oxide and/or dysprosium oxide.

Freer et al., U.S. Pat. No. 9,751,079 describes mixed metal oxide ceramics deposited on a perovskite (calcium titanium oxide) support. The catalytically active metal oxide material disposed on the supports comprises two different lanthanide elements. Dysprosium and praseodymium are both lanthanides.

The surface of dysprosium oxide- and praseodymium oxide-based films has been investigated by atomic-force microscopy and electron probe X-ray microanalysis. It is known that the electrical conductivity of Dy₂O₃ films can be substantially changed by introducing dopants of zirconium and praseodymium oxides into the initial solution used for synthesizing the films in particular, the ZrO₂-based dopant increases the electrical conductivity of the Dy₂O₃ film and the PrOr-based dopant affects the conductivity in a complex way. See P. A. Tikhonov et al. (March 2005) “Investigation of the surface structure of dysprosium and praseodymium oxide-based polycrystalline films sensitive to ozone and vapors of ethanol and methanol,” Glass Physics and Chemistry 31: 252-258. See also Baytak and Aslanoglu (24 May 2022) “Praseodymium Doped Dysprosium Oxide-carbon Nanofibers Based Voltammetric Platform for the Simultaneous Determination of Sunset Yellow and Tartrazine,” Electroanalysis 35(2): e202200136. This reference describes an electrode surface-modified to support praseodymium-doped dysprosium oxide-carbon nanofibers. The electrode is used in an electrochemical assay to measure the concentration of “Sunset Yellow” and tartrazine simultaneously. (“Sunset Yellow” and tartrazine are orange/yellow food and cosmetic dyes. In the United States, “Sunset Yellow” is labeled as “FD&C Yellow 6.” In Europe it is labeled as “E110.” Tartrazine is labeled “FD&C Yellow 5” in the U.S. and E102 in Europe.)

### SUMMARY

Disclosed herein are catalyst supports comprising dysprosium and praseodymium oxides, supported catalysts comprising the catalyst supports, and use of these supported catalysts to catalyze ammonia synthesis and ammonia degradation reactions.

In specific, non-limiting versions, the catalyst support may comprise about 1 wt % praseodymium oxide, about 10 wt % praseodymium oxide, about 20 wt % praseodymium oxide, about 30 wt % praseodymium oxide, about 40 wt % praseodymium oxide, about 50 wt % praseodymium oxide, about 67 wt % praseodymium oxide, about 80 wt % praseodymium oxide, about 90 wt % praseodymium oxide, about 95 wt % praseodymium oxide, or about 98 wt % praseodymium oxide.

Also disclosed herein is a supported catalyst comprising a catalyst support as recited in the immediately preceding paragraph and a catalytically active material deposited on the support. In one version of the supported catalyst, the catalytically active material comprises a metal. Exemplary, non-limiting metals that can be used include transition metals. Specific, non-limiting examples of transition metals that may be used include iron, cobalt, nickel, copper, technetium, ruthenium, rhodium, palladium, silver, rhenium, osmium, iridium, platinum, gold, and mercury.

Further disclosed herein is a method of making ammonia. The method comprises contacting H₂ and N₂ with a supported catalyst as disclosed herein, for a time, at a pressure, and at a temperature wherein at least a portion of the H₂ and N₂ react with one another to yield ammonia.

Also disclosed herein is a method of degrading ammonia. The method comprises contacting ammonia with a supported catalyst as disclosed herein, for a time, at a pressure, and at a temperature wherein at least a portion of the ammonia is degraded to yield H₂ and N₂.

The objects and advantages of the invention will appear more fully from the following detailed description of the preferred embodiment of the invention made in conjunction with the accompanying drawings.

### BRIEF DESCRIPTION OF THE DRAWING

FIG. 1 shows X-ray powder diffraction (XRD) spectra of mixed Pr:Dy oxide supports: 50 wt % Pr (trace 10); 67 wt % Pr (trace 12); 80 wt % Pr (trace 14); 95 wt % Pr (trace 16); 98 wt % Pr (trace 18); Pr₂O₃ (trace 20). The characterization was conducted using a Rigaku Miniflex 2 (Rigaku Corporation, Tokyo, Japan) with D/teX Ultra detector with a scan speed of 2 2θ/min over a range of 20° to 80°.

FIG. 2 is a graph depicting ammonia synthesis rates (mmol ammonia/gram catalyst/hour) as a function of praseodymium oxide content (wt %) in a mixed praseodymium/dysprosium oxide supported 1 wt % ruthenium catalyst.

FIG. 3 is a graph depicting ammonia synthesis rates (mmol ammonia/gram catalyst/hour, Y-axis on left) as a function of time (X-axis) and temperature (Y-axis on right) for a 1 wt % ruthenium catalyst deposited on a 1:1 wt % praseodymium oxide:dysprosium oxide support (“Pr:Dy oxide”). This graph reflects the stability over time of the tested catalyst at typical reaction temperatures.

FIG. 4 is a graph depicting ammonia synthesis rates as a percentage of the maximum rate for a catalyst comprising 1 wt % ruthenium deposited on a Pr:Dy oxide (95% praseodymium oxide) support and a praseodymium oxide (Pr₂O₃) support. Stability of the Pr:Dy oxide supported catalyst and the praseodymium oxide supported catalyst for ammonia synthesis were compared over a period of about 7 days.

FIG. 5 is a graph depicting percent ammonia decomposition as a function of temperature for two different supported catalysts: a 1 wt % ruthenium catalyst deposited on a 1:1 Pr:Dy oxide support (trace 10) and a 1 wt % ruthenium catalyst disposed on a praseodymium oxide (Pr₂O₃) support (trace 12). Conditions: 100% NH₃; 5400 mL/g_{CAT}/hour; pressure=1 bar.

FIG. 6 is a graph depicting percent ammonia decomposition as a function of temperature for 1 wt % ruthenium catalyst deposited on a Pr:Dy oxide support comprising various percentages of praseodymium oxide (50%, 67%, 80%, 95%, 98%, and 100%). Conditions: 100% NH₃; 5400 mL/g_{CAT}/hour; pressure=1 bar.

FIG. 7 is a graph depicting percent ammonia decomposition rate as a percentage of the maximum rate for a catalyst comprising 1 wt % ruthenium deposited on a Pr:Dy oxide (95% praseodymium oxide) support and a praseodymium oxide (PrOx) support. Stability of the Pr:Dy oxide supported catalyst and the praseodymium oxide supported catalyst for ammonia decomposition were compared over a period of about 150 hours.

### DETAILED DESCRIPTION

### Abbreviations and Definitions

The term “transition metal” means any element in Groups 3-12 of the period table of elements (i.e., d-block elements). Thus, included within the definition are scandium, titanium, vanadium, chromium, manganese, iron, cobalt, nickel, copper, zinc, yttrium, zirconium, niobium, molybdenum, technetium, ruthenium, rhodium, palladium, silver, cadmium, lanthanum, hafnium, tantalum, tungsten, rhenium, osmium, iridium, platinum, gold, mercury, actinium, rutherfordium, dubnium, seaborgium, bohrium, hassium, meitnerium, darmstadtium, roentgenium, and copernicium.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

All references to singular characteristics or limitations of the disclosed method shall include the corresponding plural characteristic or limitation, and vice-versa, unless otherwise specified or clearly implied to the contrary by the context in which the reference is made. The indefinite articles “a” and “an” mean “one or more.”

As used herein, the term “or” is an inclusive “or” operator and is equivalent to the term “and/or” unless the context clearly dictates otherwise.

All combinations of method steps disclosed herein can be performed in any order, unless otherwise specified or clearly implied to the contrary by the context in which the referenced combination is made.

The methods and compositions of matter disclosed herein can comprise, consist of, or consist essentially of the essential elements and steps described herein, as well as any additional or optional ingredients, components, or limitations described herein or otherwise useful in the fields of supported catalysts and/or heterogenous catalysis. The disclosure provided herein suitably may be practiced in the absence of any element which is not specifically disclosed herein.

### The Catalyst Support

Newly developed and disclosed herein are catalyst supports comprising dysprosium and praseodymium oxides.

Praseodymium oxides provide strong electrical effects while acting as a support for heterogenous catalysis applications. In previous findings, adding dopants to the praseodymium oxide supports led to an increase in the stability of the catalysts, typically corresponding to a small decrease in activity. In the present disclosure, novel mixed metal oxide supports were synthesized using simple methods such as co-precipitation of praseodymium and dysprosium salts. Catalysts based on these supports, with varying ratios of praseodymium to dysprosium, showed much higher activity for both ammonia synthesis and decomposition than praseodymium oxide alone.

Presently, there are many alternative options for catalyst support. Typical supports include alumina, ceria, silica and magnesium oxide. Although other choices are available, these typically explore a cost vs. improvement comparison as other supports are very cheap. The catalyst support disclosed herein is much more active than these traditional supports, and typically the cost of a catalyst (if it is stable) is less important than the overall activity. The catalyst support disclosed herein is also superior to the single metal oxide catalyst support (e.g., praseodymium oxide alone) for ammonia synthesis. The addition of dysprosium oxide promotes the activity.

The amount of praseodymium oxide and dysprosium oxide comprised in the catalyst support is not particularly limited.

In specific, non-limiting versions, the catalyst support may comprise about 1 wt % praseodymium oxide, about 10 wt % praseodymium oxide, about 20 wt % praseodymium oxide, about 30 wt % praseodymium oxide, about 40 wt % praseodymium oxide, about 50 wt % praseodymium oxide, about 67 wt % praseodymium oxide, about 80 wt % praseodymium oxide, about 90 wt % praseodymium oxide, about 95 wt % praseodymium oxide, or about 98 wt % praseodymium oxide.

In specific, non-limiting versions, the catalyst support may comprise about 2 wt % dysprosium oxide, about 5 wt % dysprosium oxide, about 10 wt % dysprosium oxide, about wt % dysprosium oxide, about 33 wt % dysprosium oxide, about 50 wt % dysprosium oxide, about 60 wt % dysprosium oxide, about 70 wt % dysprosium oxide, about 80 wt % dysprosium oxide, about 90 wt % dysprosium oxide, or about 99 wt % dysprosium oxide.

### The Supported Catalyst and its Use

Also disclosed herein are supported catalysts comprising the catalyst support as described above and a catalytically active material deposited on the support. The catalytically active material may be any substance suitable for catalyzing a chemical reaction.

In one version of the supported catalyst, the catalytically active material comprises a metal. Exemplary, non-limiting metals that can be used include transition metals. Specific, non-limiting examples of transition metals that may be used include iron, cobalt, nickel, copper, technetium, ruthenium, rhodium, palladium, silver, rhenium, osmium, iridium, platinum, gold, and mercury.

The supported catalyst may be used in various processes for facilitating chemical reactions by providing enhanced catalytic activity and stability. Further disclosed herein is a method of making ammonia. The method comprises contacting H₂ and N₂ with a supported catalyst as disclosed herein, for a time, at a pressure, and at a temperature wherein at least a portion of the H₂ and N₂ react with one another to yield ammonia. Also disclosed herein is a method of degrading ammonia. The method comprises contacting ammonia with a supported catalyst as disclosed herein, for a time, at a pressure, and at a temperature wherein at least a portion of the ammonia is degraded to yield H₂ and N₂.

### Examples

### Support Synthesis

Praseodymium nitrate and dysprosium nitrate were used as precursors for the support. The salts were dissolved in de-ionized (“DI”) water and then dropped into a beaker of ammonium hydroxide at a rate of 2 mL/min. The mixture was allowed to stir for two hours before being filtered. Following this, the precipitate was permitted to dry before being calcined in air at 700° C. for 5 hours. The oxide thus formed was then crushed to the desired size.

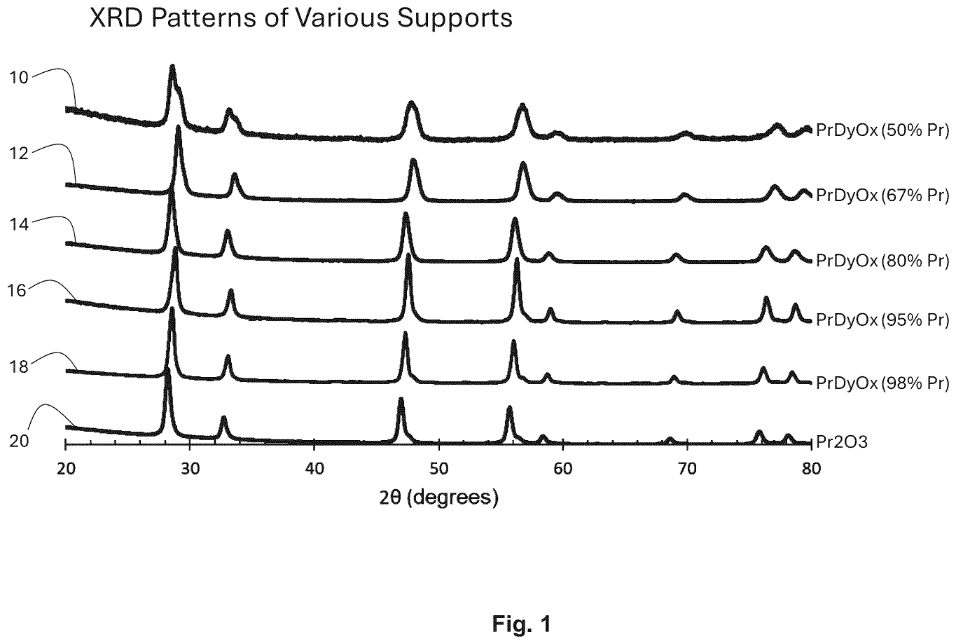

FIG. 1 shows X-ray powder diffraction spectra (XRD) of mixed Pr:Dy oxide supports: 50 wt % Pr (trace 10); 67 wt % Pr (trace 12); 80 wt % Pr (trace 14); 95 wt % Pr (trace 16); 98 wt % Pr (trace 18); Pr₂O₃ (trace 20). As shown in the figure, the traces were consistent across the compositions tested.

### Ruthenium-Based Supported Catalyst Preparation

Triruthenium dodecacarbonyl was dissolved in tetrahydrofuran.

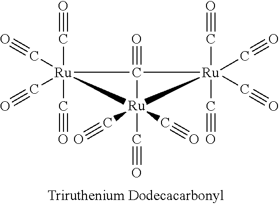

While stirring, praseodymium oxide and dysprosium oxide (formed as described above) were added (in various concentrations) to the solution. The solution was stirred, and the tetrahydrofuran evaporated. Once completely dry, the supported catalysts were calcined in argon for 3 hours at 350° C. in a tube furnace. Following this, the catalysts were transferred to a new furnace where they were reduced under a blanket of hydrogen for 1 hour at 500° C. Catalytic testing was then completed under reaction gases and analyzed with a Shimadzu GC-2014s gas chromatography system (Shimadzu Corporation, Kyoto, Japan).

### Ammonia Synthesis Using the Supported Catalyst

The supported ruthenium catalyst made as described above was then used to catalyze the synthesis of ammonia from molecular hydrogen and molecular nitrogen. Analogous supported catalysts were also made using magnesia as the support and praseodymium oxide alone as the support. The reactions were carried out at 400° C. and a pressure of 30 bar, using a stoichiometric 1:1 mixture of H₂ to N₂. The space velocity for the ammonia synthesis was 36,000 mL/g_{cat}/hr with a total flow rate of 120 mL/min for 0.2 g of catalyst. The results are shown in Table 1.

TABLE 1
Ammonia Synthesis Catalyst Testing Data

| | | Ammonia |
|---|---|---|
| | | Synthesis Rate |
| | Catalyst | (mmol/g_{cat}/hr) |
| 1. | 1 wt. % Ru/MgO | 1.30 ± 0.11 |
| 2. | 1 wt. % Ru/Pr₂O₃ | 9.42 ± 0.80 |
| 3. | 1 wt. % Ru/Pr₂O₃—Dy₂O₃ (50% Praseodymium | 18.91 ± 1.54 |
| | Oxide) | |
| 4. | 1 wt. % Ru/Pr₂O₃—Dy₂O₃ (67% Praseodymium | 21.44 ± 1.75 |
| | Oxide) | |
| 5. | 1 wt. % Ru/Pr₂O₃—Dy₂O₃ (80% Praseodymium | 24.95 ± 2.04 |
| | Oxide) | |
| 6. | 1 wt. % Ru/Pr₂O₃—Dy₂O₃ (95% Praseodymium | 15.28 ± 1.25 |
| | Oxide) | |
| 7. | 1 wt. % Ru/Pr₂O₃—Dy₂O₃ (98% Praseodymium | 17.67 ± 1.44 |
| | Oxide) | |

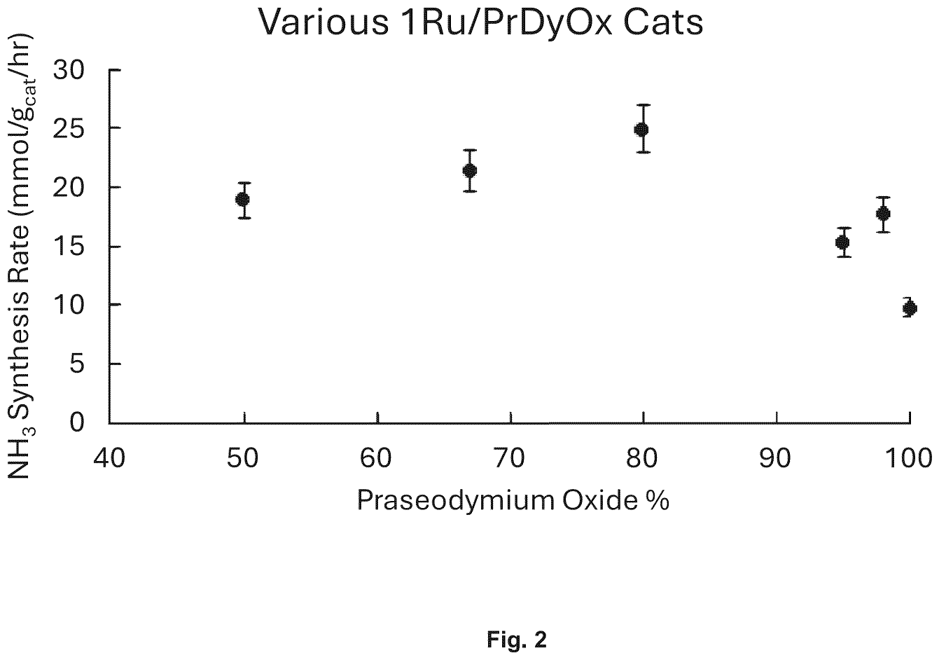

As can be seen from Table 1, the ruthenium catalyst supported on a mixed praseodymium oxide/dysprosium oxide support (entries 3-7) had far better catalytic activity than the same ruthenium catalyst deposited on a magnesia support (entry 1) or a praseodymium oxide (alone) support (entry 2). The best results were attained with a supported catalyst comprising 1 wt % ruthenium deposited on a support comprising 80 wt % praseodymium oxide and 20 wt % dysprosium oxide (entry 5). The data from Table 1 is presented graphically in FIG. 2.

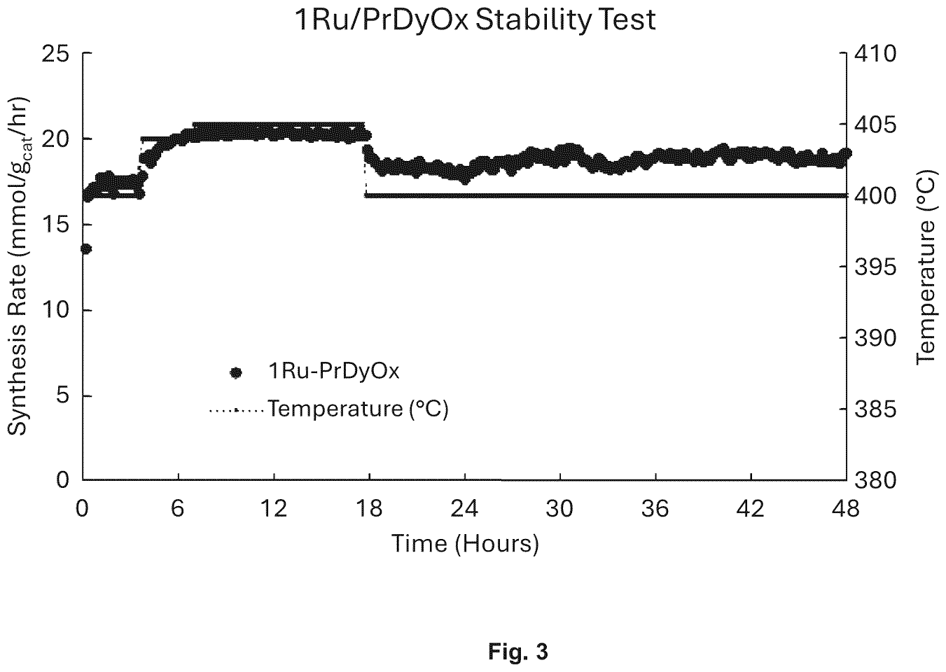

A 50 wt % praseodymium oxide/50 wt % dysprosium oxide support onto which was deposited 1 wt % ruthenium (made as described above) was tested for its ammonia synthesis rate over time and at various temperatures. The feed stock and pressure conditions of the reaction were the same as noted above: a 1:1 mixture of molecular hydrogen and molecular nitrogen was passed over the catalyst at a pressure of 30 bar. The temperature was set at 400° C. for six (6) hours of continuous operation and then ramped to 405° C. for 12 hours of continuous operation, and then reduced back to 400° C. for 30 hours of continuous operation. Thus, the experiment ran for 48 continuous hours. The results are shown in FIG. 3. As shown in the figure, trace 10 records the temperature (Y-axis on right). Trace 20 shows the synthesis rate of ammonia under the stated condition (in mmol ammonia per gram of catalyst per hour). As can be seen from the figure, the rate of ammonia production increased with increased temperature, fell slightly when the temperature was dropped back to 400° C., and remained steady over the 48-hour run time of the experiment. These results demonstrate that the supported catalyst is stable over time at typical reaction temperatures.

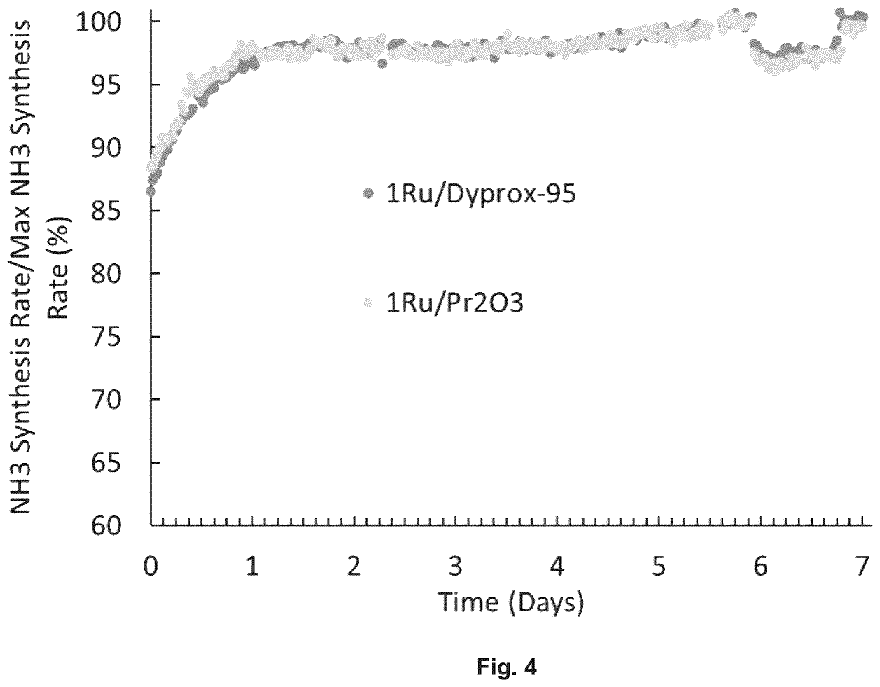

The ammonia synthesis rate was also tested over a period of about 7 days using a catalyst 1 wt % ruthenium catalyst deposited onto a Pr:Dy oxide support comprising 95% praseodymium oxide and a Pr₂O₃ (alone) support. The results are shown in FIG. 4. As shown in the figure, the ammonia production rate using the Pr:Dy oxide supported catalyst and the Pr₂O₃ supported catalyst exhibited similar trends: both increased on day 1 and remained steady over the following six days. The results demonstrate that the Pr:Dy oxide supported catalyst exhibits comparable stability to the Pr₂O₃ supported catalyst.

### Ammonia Degradation Using the Supported Catalyst

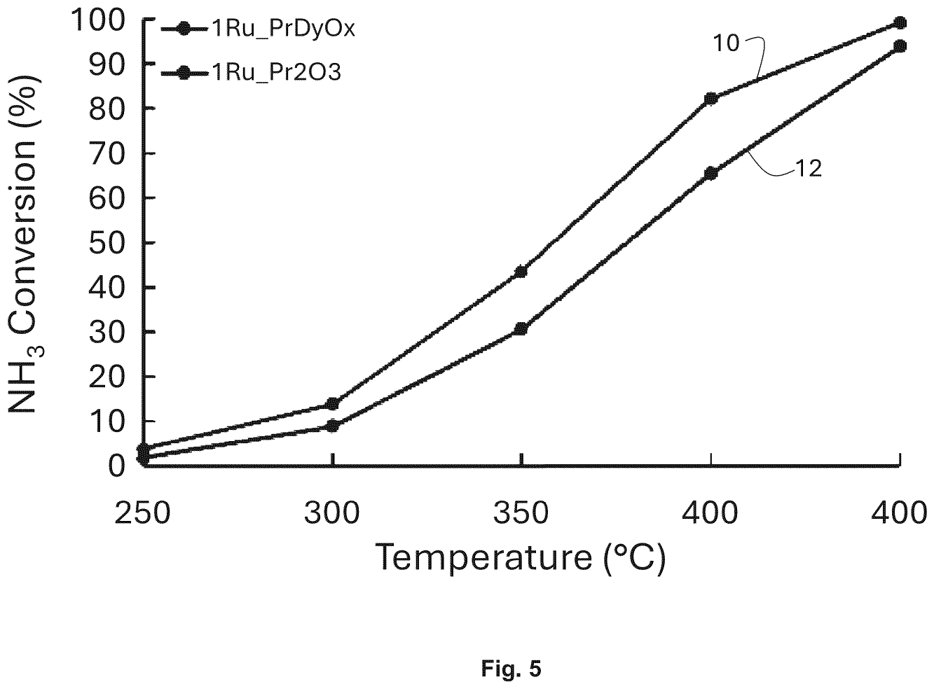

A supported catalyst made as described (1 wt % ruthenium deposited on a support comprising 1:1 wt % praseodymium oxide and dysprosium oxide) was tested for its ability to degrade ammonia into molecular hydrogen and nitrogen over a range of temperatures. For control, an analogous supported catalyst was made using only praseodymium oxides as the support. The reaction conditions were 100% NH₃ feed at 5400 mL/g_{CAT}/hour at a pressure 1 bar. The results are shown in FIG. 5. In the figure, the results for the ruthenium catalyst disposed on the 1:1 Pr oxide-to-Dy oxide support are shown in trace 10. The results for the ruthenium catalyst disposed on a praseodymium oxide (Pr₂₀₃) support are shown in trace 12. As is readily apparent from the figure, the catalyst disposed on the 1:1 Pr oxide-to-Dy oxide support gave superior results at all temperatures tested (300° C., 350° C., 400° C., and 450° C.).

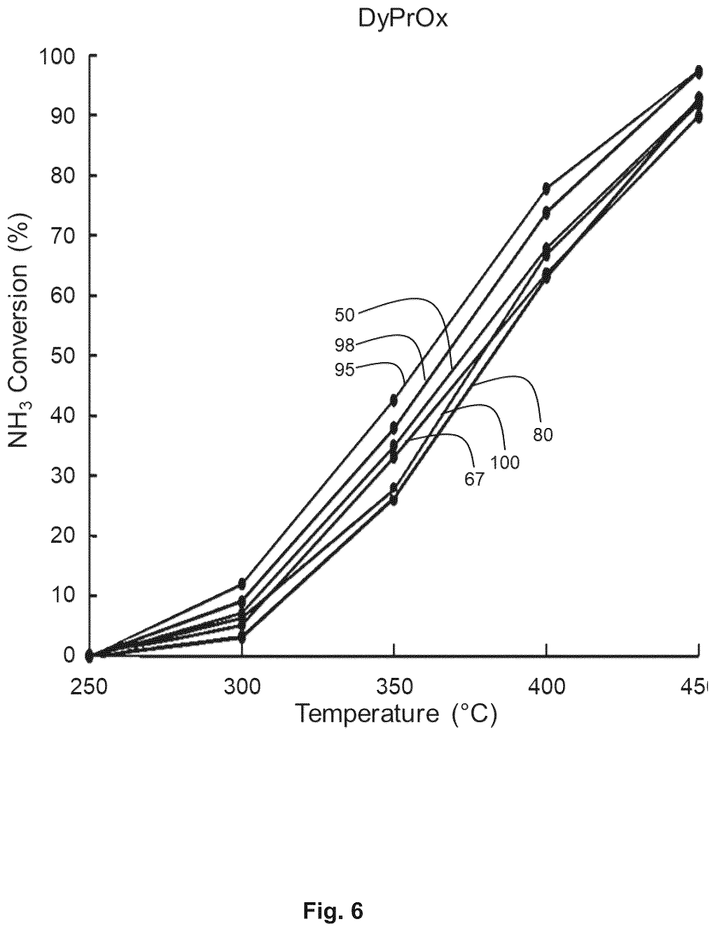

Subsequently, ammonia degradation of the 1 wt % ruthenium catalyst deposited on a Pr:Dy oxide support comprising various percentages of praseodymium oxide was tested over a range of temperatures. The reaction conditions were the same as noted above: 100% NH₃ feed at 5400 mL/g_{CAT}/hour at a pressure 1 bar. The results are shown in FIG. 6. As shown in the figure, the best results were attained with a 1 wt % ruthenium catalyst deposited on a support comprising 95 wt % praseodymium oxide (and 5 wt % dysprosium oxide).

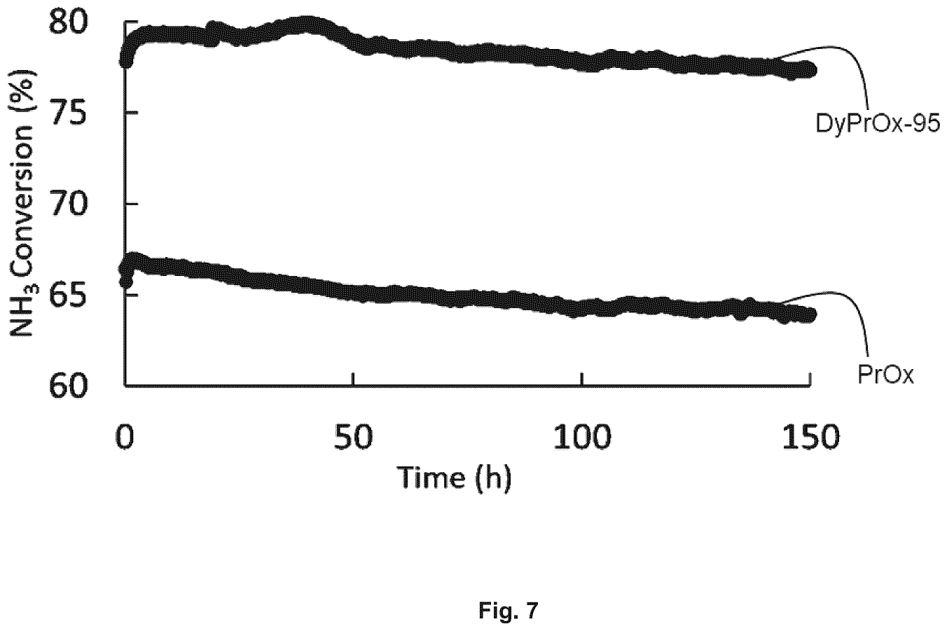

Stability of the 1 wt % ruthenium catalyst deposited on a Pr:Dy oxide was compared to the 1% ruthenium catalyst deposited on a praseodymium oxide (alone) support for ammonia decomposition over a period of 150 hours. The results are shown in FIG. 7. As shown in the figure, the Pr:Dy oxide supported catalyst resulted in superior ammonia conversion rate compared to the praseodymium oxide supported catalyst. The ammonia conversion rate remained steady throughout the testing period, with only minor decreases, indicating the stability of the Pr:Dy oxide supported catalyst.

What is claimed is:

1. A catalyst support comprising praseodymium oxide and dysprosium oxide.

2. The catalyst support of claim 1, comprising about 1 wt % praseodymium oxide.

3. The catalyst support of claim 1, comprising about 10 wt % praseodymium oxide.

4. The catalyst support of claim 1, comprising about 20 wt % praseodymium oxide.

5. The catalyst support of claim 1, comprising about 30 wt % praseodymium oxide.

6. The catalyst support of claim 1, comprising about 40 wt % praseodymium oxide.

7. The catalyst support of claim 1, comprising about 50 wt % praseodymium oxide.

8. The catalyst support of claim 1, comprising about 67 wt % praseodymium oxide.

9. The catalyst support of claim 1, comprising about 80 wt % praseodymium oxide.

10. The catalyst support of claim 1, comprising about 90 wt % praseodymium oxide.

11. The catalyst support of claim 1, comprising about 95 wt % praseodymium oxide.

12. The catalyst support of claim 1, comprising about 98 wt % praseodymium oxide.

13. A supported catalyst comprising a catalyst support as recited in claim 1 and a catalytically active material deposited on the support.

14. The supported catalyst of claim 13, wherein the catalytically active material comprises a metal.

15. The supported catalyst of claim 14, wherein the metal is selected from the group consisting of transition metals.

16. The supported catalyst of claim 14, wherein the metal is selected from the group consisting of iron, cobalt, nickel, copper, technetium, ruthenium, rhodium, palladium, silver, rhenium, osmium, iridium, platinum, gold, and mercury.

17. A method of making ammonia, the method comprising contacting H₂ and N₂ with a supported catalyst as recited in claim 13, for a time, at a pressure, and at a temperature wherein at least a portion of the H₂ and N₂ react with one another to yield ammonia.

18. A method of degrading ammonia, the method comprising contacting ammonia with a supported catalyst as recited in claim 13, for a time, at a pressure, and at a temperature wherein at least a portion of the ammonia is degraded to yield H₂ and N₂.
